(19) United States
(12) Patent Application Publication
(10) Pub. No.: US 2016/0244951 A1
(43) Pub. Date: Aug. 25, 2016

(54) DEVICES AND METHODS FOR COLLECTING, SANITIZING, AND DISPENSING CONDENSED FORMS OF ATMOSPHERIC WATER

(71) Applicant: George Yui, Toronto (CA)

(72) Inventor: George Yui, Toronto (CA)

(21) Appl. No.: 15/049,034

(22) Filed: Feb. 20, 2016

Related U.S. Application Data
(60) Provisional application No. 62/118,568, filed on Feb. 20, 2015.

(51) Int. Cl. E03B 3/28; E03B 11/02; C02F 1/04; E03B 7/07

(52) U.S. Cl. CPC E03B 3/28; E03B 7/074; E03B 11/02; C02F 1/04; C02F 2303/04

(57) ABSTRACT

Devices and methods for condensing, cooling, heating, sanitizing, and dispensing drinkable water that is collected from atmospheric water vapor are disclosed. The devices generally include a dehumidifier that is configured to harvest and condense atmospheric water vapor within the device; and a collection tank that is configured to receive and collect condensed atmospheric water vapor within the dehumidifier. The devices further include a first means for heating water within the collection tank to a temperature that is effective to kill bacteria; and a first tube that fluidly connects the collection tank with a cold water tank. The first tube includes one or more in-line filters through which water must travel to reach the cold water tank. The devices further include a second means for heating water within the cold water tank to a temperature that is effective to kill bacteria, and a second tube that fluidly connects the cold water tank with a hot water tank.

### CROSS-REFERENCE TO RELATED APPLICATIONS

This application claims priority to and incorporates by reference U.S. provisional patent application Ser. No. 62/118,568, filed Feb. 20, 2015.

### FIELD OF THE INVENTION

The field of the invention relates to devices and methods for collecting, sanitizing, and dispensing condensed forms of atmospheric water and, more particularly, to devices and methods for collecting, condensing, cooling, heating, sanitizing, and dispensing drinkable water that is collected from atmospheric water vapor.

### BACKGROUND OF THE INVENTION

For many years, there has been a significant demand for devices and methods that may be deployed to harvest atmospheric water vapor, condense that water vapor into a volume of water, and then sanitize such water for the purpose of human consumption. Such demand is particularly prevalent in areas where conventional water supplies are unable to consistently and safely deliver quality drinking water (without the associated environmental consequences of currently-available solutions, such as packaging water in plastic bottles). Others have attempted to create devices that are capable of harvesting and sanitizing drinkable water from the surrounding atmosphere; however, such attempts have largely failed. Many of those attempts have not provided adequate means of sanitizing collected water, which is a significant problem given the large volume of air that is needed to collect a meaningful amount of water (and the large number and variety of bacteria and other impurities that are found in the atmosphere).

As the following will demonstrate, the devices and methods described herein address many of these (and other) demands in the marketplace.

### SUMMARY OF THE INVENTION

According to certain aspects of the invention, devices and methods for collecting, condensing, cooling, heating, sanitizing, and dispensing drinkable water (in both cold and hot forms) that is harvested from atmospheric water vapor are disclosed. In certain embodiments, the devices generally include a dehumidifier that is configured to collect and condense atmospheric water vapor within the device, along with a collection tank that is configured to receive and collect condensed atmospheric water vapor within the dehumidifier. The invention provides that the devices further include a first means (e.g., an electric/water-safe heating element) that is configured to heat the water contained within the collection tank to a temperature that is effective to kill contaminating bacteria. The invention provides that a first tube fluidly connects the collection tank with a cold water tank. Still further, the invention provides that the first tube includes one or more in-line filters through which water must travel to reach the cold water tank, with the one or more filters being configured to remove unwanted contaminants from the harvested water.

According to such embodiments, the devices further include a second means (e.g., an electric/water-safe heating element) for heating the water contained within the cold water tank to a temperature that is effective to kill bacteria (this heating step may be carried out periodically, and at defined time points, as instructed by a programmable control board of the device). The invention provides that the devices further include a second tube that fluidly connects the cold water tank with a hot water tank (with the second tube being configured to enable convective mixing of hot and cold water in the hot tank). The devices further include one or more additional tubes for delivering cold water from the cold water tank and hot water from the hot water tank to an external faucet. Still further, the devices of the present invention include certain safety features that prevent the dispensing of hot water from the device during a sanitization procedure (to avoid accidental scalding of an operator of the device). As described and illustrated further below, the devices may exhibit various embodiments and configurations; however, such embodiments share the ability to safely and effectively collect, condense, cool, heat, sanitize, and dispense drinkable water (in both cold and hot forms) that is harvested from atmospheric water vapor.

The devices and methods of the present invention set forth above are described in further detail below in the Detailed Description of the Invention section.

### BRIEF DESCRIPTION OF THE DRAWINGS

FIG. 1 is a diagram that illustrates a preferred embodiment of the devices described herein.

FIG. 2 is a diagram that illustrates another embodiment of the devices described herein, which excludes a UV lamp and has only a single faucet.

FIG. 3 is a diagram that illustrates another embodiment of the devices described herein, which shows (among other things) an internal heating element installed within the cold water tank (for use during a sanitization cycle).

FIG. 4 is a diagram that illustrates another embodiment of the devices described herein, showing (among other things) alternative means for heating water that is contained in the cold water tank and collection tank.

FIG. 5 is a diagram that illustrates another embodiment of the devices described herein, which shows (among other things) a three-way solenoid valve installed onto the steam release line.

FIG. 6 is a diagram that illustrates another embodiment of the devices described herein, which shows (among other things) the use of an in-line heater, as described herein.

FIG. 7 is a diagram that illustrates another embodiment of the devices described herein, which shows (among other things) the use of a heater being connected to the collection tank, with a solenoid valve controlling recirculation of the water inside the collection tank for sanitization procedures.

FIG. 8 is a diagram that illustrates another embodiment of the devices described herein, which is similar to the embodiment shown in FIG. 6, with the exception that the in-line heater is mounted after a filter within the same line (for heating and sanitizing water before it is delivered to the cold water tank).

FIG. 9 is a diagram that illustrates another embodiment of the devices described herein, which shows (among other things) the use of a single compressor to cool water that is held within the cold water tank and the dehumidifier.

FIG. 10 is a diagram that illustrates another embodiment of the devices described herein, which shows (among other things) the means by which the devices may restrict the cold water faucet from dispensing hot water during a hot water sanitization procedure. FIG. 10A shows the safety feature in an open/unlocked position (such that cold water is permitted to flow from the faucet), whereas FIG. 10B shows the safety feature in a closed/locked position (such that cold water is not permitted to flow from the faucet, since the device is then undergoing a sanitization cycle).

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

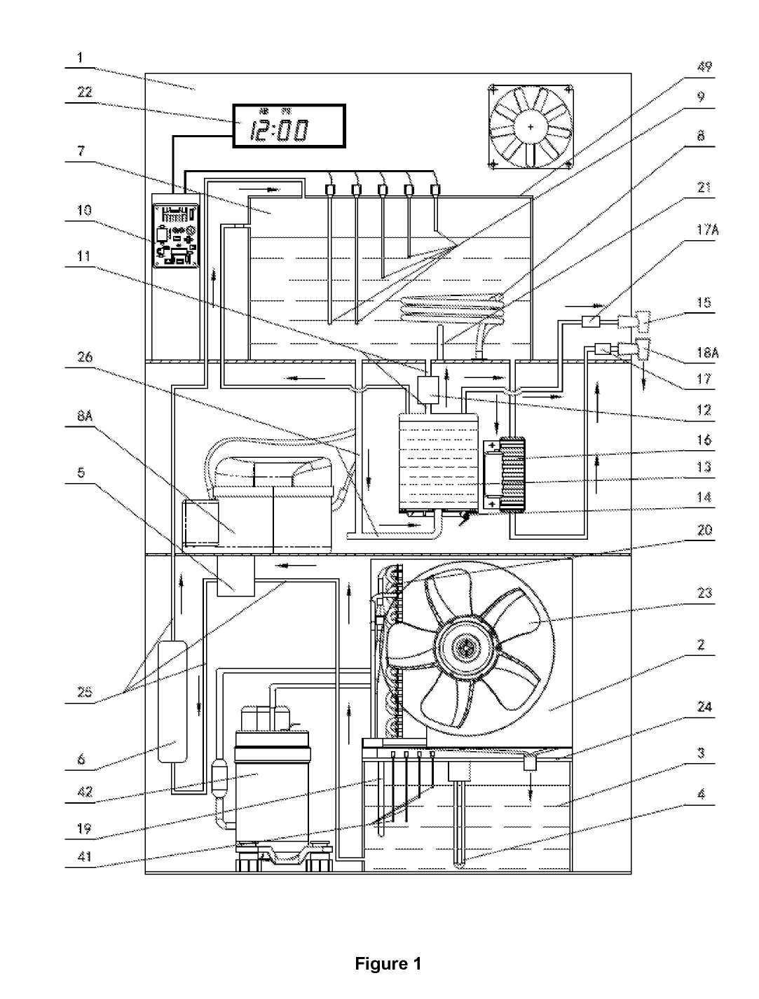

Referring now to FIGS. 1-10, the devices include a dehumidifier (2) that is located near the bottom portion of the device cabinet (1). The dehumidifier (2) comprises a fan (23) that is configured to generate and provide large volumes of air to an evaporator (20), which is cooled by a compressor (42) that is operably coupled to the dehumidifier (2). The invention provides that atmospheric water vapor (humidity) will condense on the evaporator (20), such that the condensed water vapor will then drip down into a collection tank (3)—to form a collected body of water. The invention provides that the device includes a lid (24), which is configured to cover and protect the collection tank (3).

Referring to FIG. 1, the invention provides that the collected water is pumped from the collection tank (3) by a water pump (5) and through certain dedicated tubing (25). The dedicated tubing (25) will funnel the collected water through at least one filter (or set of filters) (6), and then into a cold water tank (7). In certain preferred embodiments, the invention provides that the filter (or set of filters) (6) will consist of a porous ceramic filter(s). The porous ceramic filter(s) (6) will be configured to remove dirt, bacteria, and other contaminants from the water.

The invention further provides that the cold water tank (7) will preferably include an evaporator or cooling coils (8), which are located within the cold water tank (7) and configured to cool the water contained therein via a refrigeration compressor (8A). The invention provides that water level sensors (9) will preferably be suspended from a lid (49) of the cold water tank (7), with the water level sensors (9) being operably connected to and in communication with an electronic control board (10). The invention further provides that water will travel from the cold water tank (7) and into a hot water tank (13)—which, in certain embodiments, will be equipped with a bottom-mounted external heater (14).

From the hot water tank (13), hot water may be dispensed from the device by a user via an external faucet (15). In addition, the invention provides that cold water may be dispensed from the cold water tank (7) through an optional point-of-dispensing ultra-violet (UV) lamp (16) that comprises a solenoid valve (17), and further through an external faucet (18A). The optional ultra-violet (UV) lamp (16) will provide yet further means for killing any remaining bacteria contained in the water. The invention provides that the device may further include a digital display (22), which is connected to the electronic control board (10). In such embodiments, the digital display (user interface) (22) may be used, for example, to display the day of the week and the time of day—and to set a desired frequency and time(s) for sanitization cycles. The invention provides that the device may, optionally, include a fan (51) located above the lid (49), which operates to drive humid air away from the ultra-violet (UV) lamp (16), display (22), and the control board (10).

According to certain preferred embodiments, the collection tank (3) will comprise its own heating element (4), which may be affixed to the lid portion (24) thereof. The collection tank (3) will preferably further comprise a temperature sensing device (19) and water level control sensors (41), both of which are operably coupled to and in communication with the control board (10). The invention provides that/during normal operation—the cold water tank (7) is connected to a hot water tank (13) via a dedicated tube (26) that is configured to deliver water through the bottom portion of the hot tank (13). The invention provides that such connection will minimize the unwanted mixing of cold and hot water, while still allowing replenishment of water in the hot water tank (13).

For sanitation purposes, the invention provides that an additional tube (11), which may be equipped with its own solenoid shut-off valve (12), may also connect the top of the hot tank (13) with the bottom of the cold tank (7). This configuration facilitates the mixing of hot and cold waters, when it is required to manage appropriate temperature levels in the hot tank (13). The invention provides that the cold water tank (7) will preferably include a temperature sensing device (21). In addition, the invention provides that a safety shut-off solenoid valve (17) is preferably located between the cold tank (7) and cold water-dispensing faucet (18A), as described further below.

The invention provides that the device described herein is particularly suited for not only harvesting and condensing atmospheric water vapor, but also for sanitizing such water (and removing contaminating bacteria and other impurities) for human consumption. Referring to FIG. 1, for example, the invention provides that the device includes three areas that are configured to apply heat to sanitize collected water. More specifically, the hot water tank (13), the water collection tank (3), and the cold water tank (7) all contain separate heating elements and, therefore, a means for heating the water contained therein to a temperature that destroys bacteria and other impurities contained in the water. In certain embodiments, the hot water tank (13) will be configured to perform a sanitization procedure during the normal working cycle. In addition, the invention provides that the collection tank (3) will preferably be heated by an internal heating element (4), at times programmed into the control board (10). This internal heating element (4) can be mounted within the device in various ways, such as by hanging the heating element (4) from the top, it may be connected to the sides of the collection tank (3), or it may be configured to sit on the bottom of the collection tank (3). In certain preferred embodiments (e.g., FIG. 1), the heating element (4) is oriented to hang down from the lid (24).

The invention provides that when the heating element (4) is switched on via the programmed control board (10), the water is heated to a point that the water achieves a desired temperature level, which is monitored by the temperature sensor (19). The temperature sensor (19) is preferably configured to issue signals to the control board (10) in order to hold the water temperature steady (and/or within a defined range) for a defined period of time. The heating element (4) may be turned off, as necessary, to control the water temperature in the collection tank (3). The invention provides that heat generated by the heating element (4) in the collection tank (3) will be allowed to permeate throughout the internal areas of the device, thereby serving to further sanitize other internal surfaces, connections, and structures within the cabinet (2) of the device.

Still further, according to certain preferred embodiments, the invention provides that the cold water tank (7) may be heated by the hot water tank (13). More specifically, the invention provides that the solenoid valve (12) located in the connecting tube (11) may be opened via the programmed control board (10), such that hot water is quickly provided to the cold water tank (7)—from the hot water tank (13). During this sanitization procedure, the refrigeration compressor (8A) is disabled by the control board (10). Following a sanitization procedure, solenoid valve (12) may be instructed to close—and the refrigeration compressor (8A) may resume to cool the heated water in the cold tank (7) to a desirable temperature.

The invention provides that in both the cold water tank (7) and collection tank (3), water can be heated to any temperature within a preferred and defined range of temperatures, such as 70° C.-85° C. Still further, the invention provides that such elevated temperatures can be maintained for any defined period of time, which may be required to kill bacteria and otherwise sanitize the internal water-containing areas of the device. The invention provides that the sanitization procedures described herein are preferably controlled by the control board (10), which may be programmed by an operator of the device through the digital display (22). Due to potentially high demands placed on the compressor (8A) (i.e., to quickly cool water that has been heated during a sanitization procedure), the control board (10) may be programmed to intermittently start and stop the refrigeration compressor (8A).

With respect to the operation of the device, the invention provides that the dehumidifier (2) collects atmospheric water vapor, which is allowed to drip into the collection tank (3). After the collected water accumulates to a certain volume, sensors (41) may cause the control board (10) to temporarily terminate power to the dehumidifier (2) function, and subsequently activate the heater (4) of the collection tank (3). The invention provides that the collected water is then heated and maintained at a selected temperature (for a programmed/defined amount of time), after which the heater (4) is powered off by the control board (10). The invention provides that a water pump (5) may then be activated to pump the water out of the collection tank (3)—immediately following a sanitization procedure or at some time thereafter to allow the water to cool—and into and through a dedicated tube (25). The dedicated tube (25) is configured to deliver the water to and through the water filter (6), after which the sanitized and filtered water is delivered to the cold tank (7) via tube (25). As mentioned above, in certain preferred embodiments, the filter (6) is a porous ceramic water filter housed within a temperature resistant casing. The invention provides that the incoming warm water is then cooled for consumption within the cold water tank (7). The cold water tank (7) is connected to the hot tank (13) via tube (26), to provide a source of water for the hot tank (13).

Still further, the invention provides that the device may be programmed (via the display (22) that communicates with the control board (10)) to cause the compressor (8A) to power off, in order to stop cooling the water in the cold water tank (7), such that the solenoid valve (12) may open to allow hot water (from the hot tank (13)) to quickly enter the cold water tank (7) through a short/dedicated tube (11)—which quickly allows hot water to mix with cold water inside the cold water tank (7).

According to certain preferred embodiments, the device is equipped with a safety feature that is configured to prevent accidental scalding by hot water that may otherwise be dispensed from the cold water faucet (18). More specifically, the invention provides that a solenoid valve (17) will be employed (in a closed position) during hot water sanitizing cycles to prevent accidental scalding. Once the water temperature returns to a safe level, the solenoid valve (17) will be opened. As explained above, the invention provides that cold and hot water may be dispensed via a two faucet design, such that cold water may be dispensed via a separate dedicated faucet (18A), while hot water may be dispensed via its own separate faucet (15).

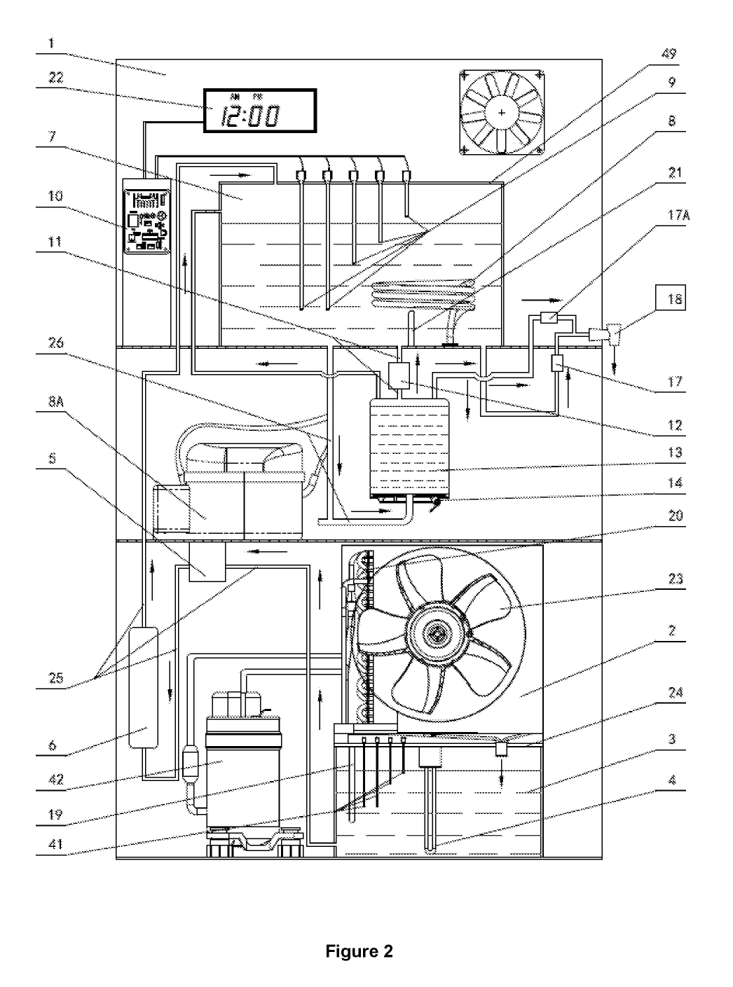

In certain alternative embodiments, as illustrated in FIG. 2, both cold and hot water may be dispensed via a single faucet (18). In the single faucet configuration of FIG. 2, the solenoid valve (17) is used to control the flow of cold water and solenoid valve (17A) is used to control the flow of hot water. The invention provides that the single faucet (18) configuration may be employed for aesthetic reasons, as well as for sanitizing the faucet with hot water flow (after dispensing cold water). The invention provides that, during normal operation, one solenoid valve must be closed while the other is open for dispensing the desired type of water (cold water or hot water), and to prevent the unwanted mixing of cold and hot waters.

In addition to the preferred embodiments shown and described herein, the present invention encompasses various alternative embodiments as well. Referring to FIG. 2, for example, the device shown therein is similar to that of FIG. 1. However, the embodiment shown in FIG. 2 does not include the optional UV Lamp (16), and (as mentioned above) is equipped with only a single faucet (18) for dispensing both hot and cold water. In such embodiments, two solenoid valves (17) and (17A) are employed to dispense one type of water (cold or hot) at any given time. The invention provides that, in such embodiments, the unopened valve must remain closed in order to prevent unwanted mixing of the cold and hot waters inside of the water dispenser.

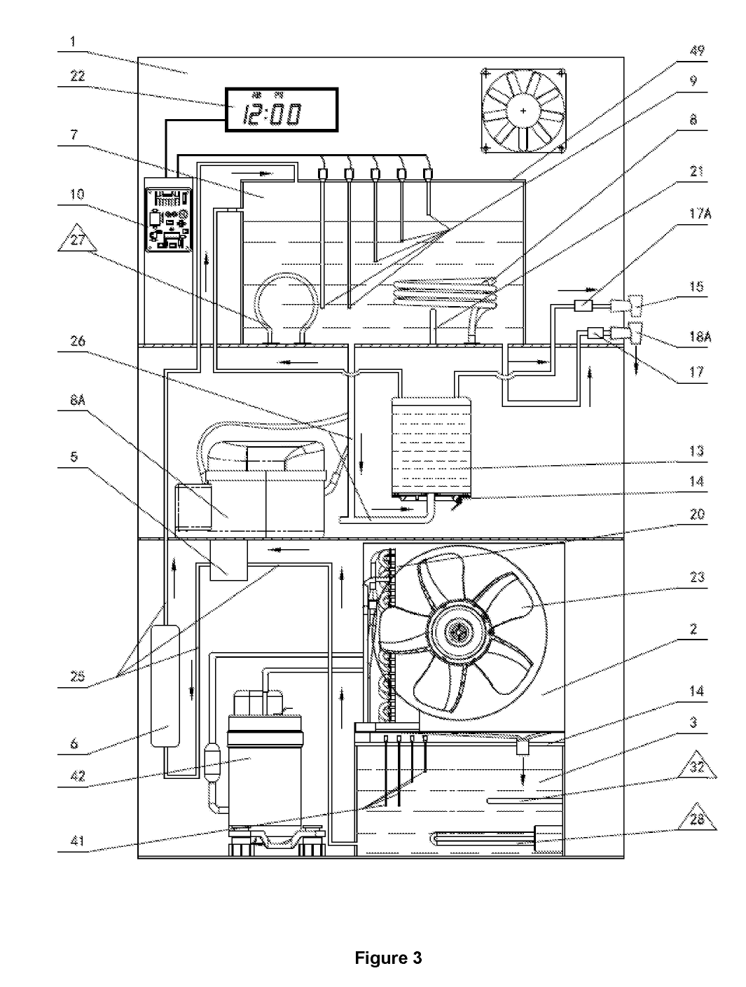

Referring now to FIG. 3, another embodiment is provided that includes an internal heater (heating element) (27) installed within the cold water tank (7). In such embodiments, the internal heater (27) is configured to heat the water during a sanitizing cycle, instead of utilizing the hot water tank (13), as in the case of the embodiment of FIG. 1. In addition, according to the embodiment shown in FIG. 3, the invention provides that a temperature sensor (32) may be installed in an alternate position, namely, it may be installed within a side wall of the collection tank (3). The invention provides that the internal heater (28), within the collection tank (3), may also be installed within a side wall thereof.

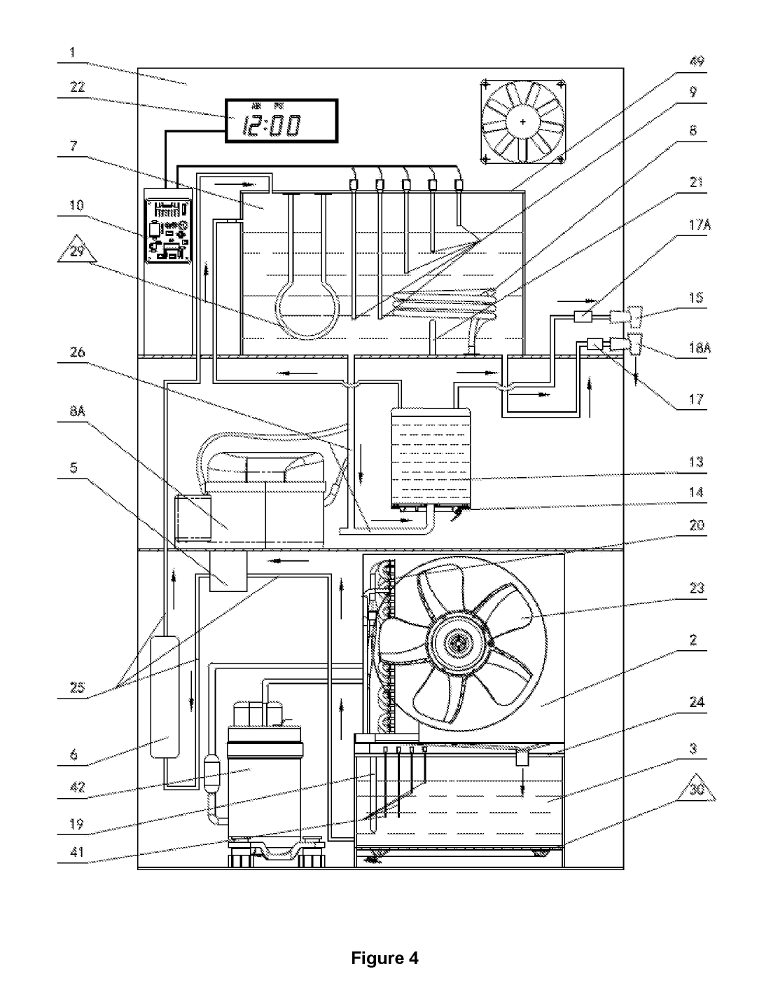

Referring now to FIG. 4, yet another embodiment is provided that employs an alternative means for heating water that is contained in the cold water tank (7) and collection tank (3). According to such embodiments, an externally- and bottom-mounted heater (30) may be employed to heat the water contained within the collection tank (3). In addition, the invention provides that a heater (19) may be suspended from the lid (24) of the collection tank (3), in order to deliver additional heat to the water contained therein during a sanitization cycle. Still further, in such embodiments, an internal heater (29) may be suspended from the lid (49) of the cold tank (7), which is also configured to deliver heat to the water contained therein during a sanitization cycle.

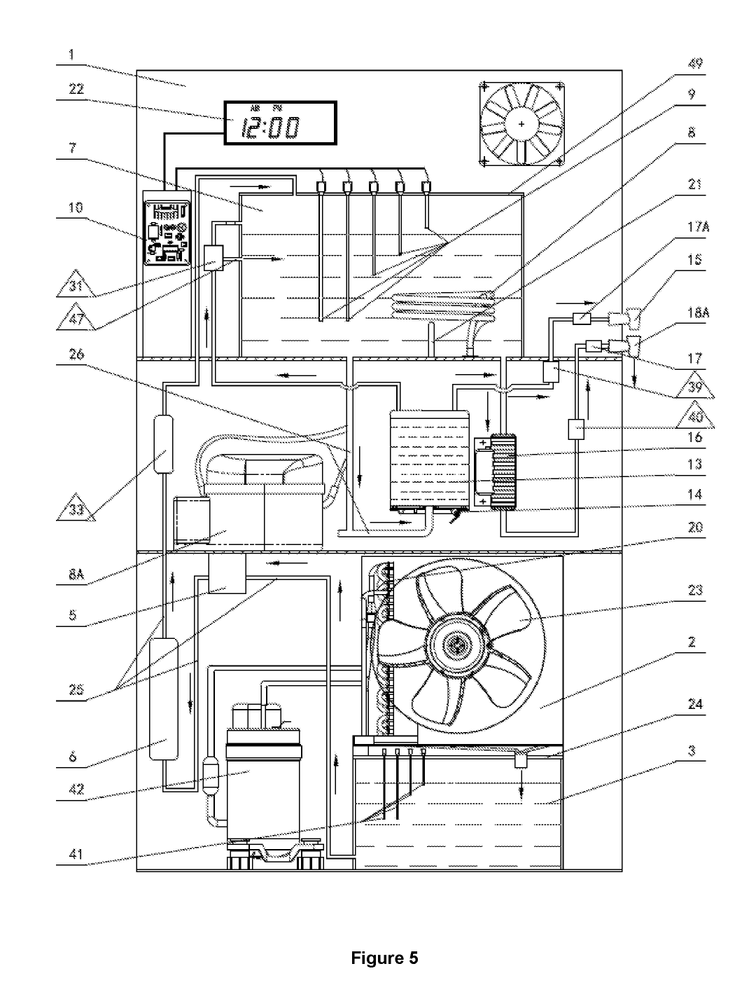

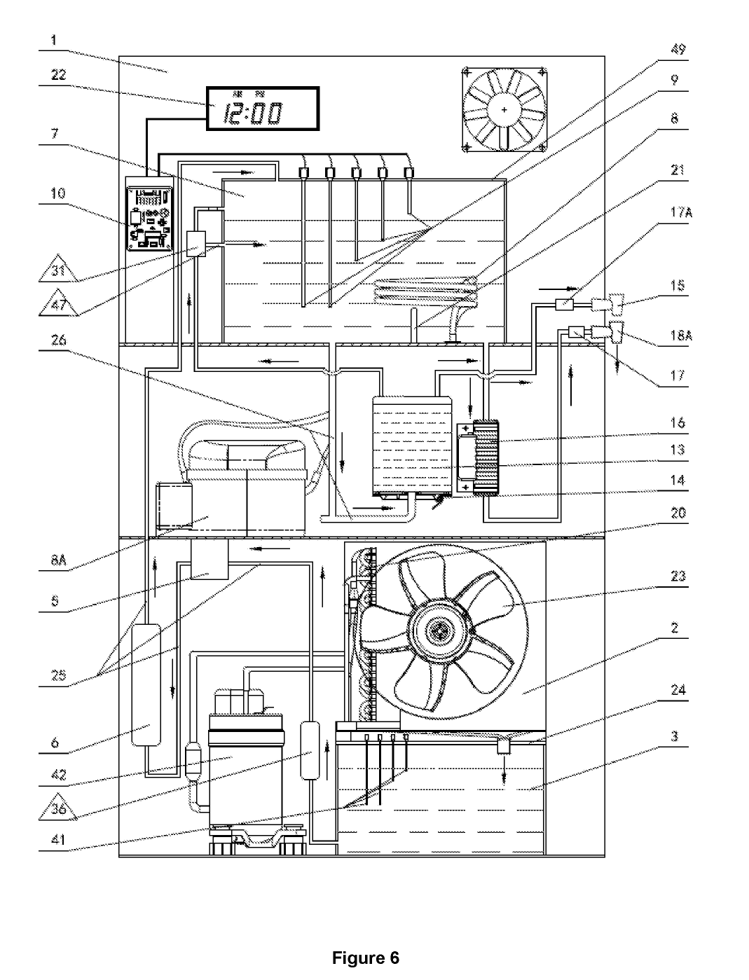

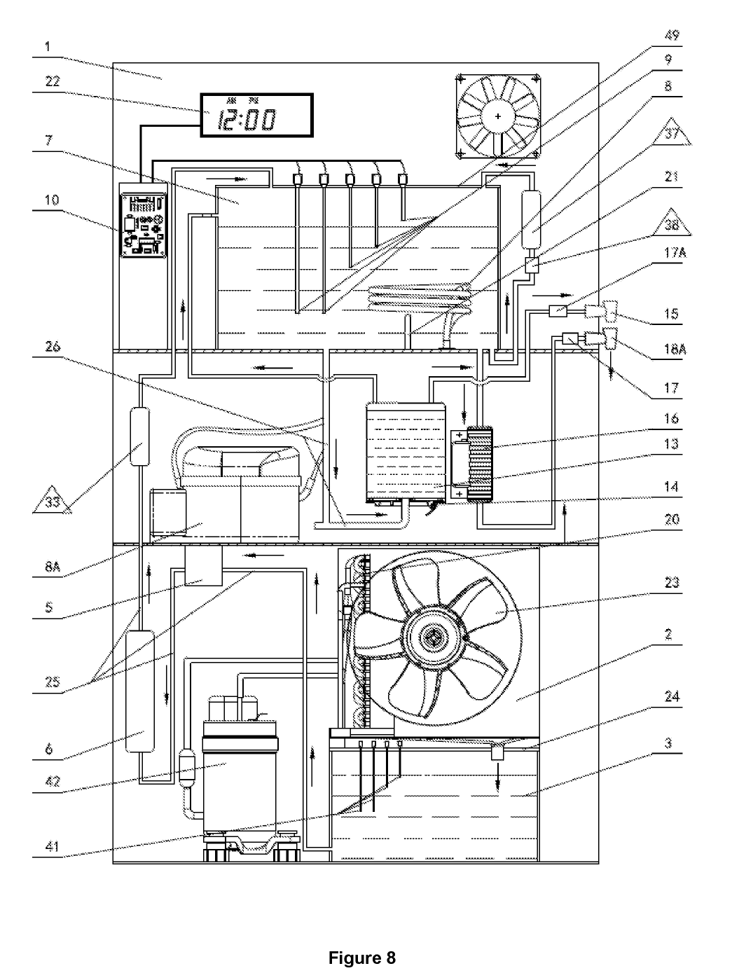

Referring now to FIG. 5, according to still further embodiments, the device may be equipped with a Y-shaped solenoid valve (31) installed onto a steam release line (50) that is coupled between the hot tank (13) and cold tank (7). During normal operation, the invention provides that the steam release line (50) is open, while line (47) remains closed. The invention provides that as heated hot water in the hot water tank (13) expands, any excess overflow will be delivered to the cold tank (7) and into the space above the cold water contained therein. Conversely, when the Y-shaped solenoid (31) is closed for the steam release line (50), and open for line (47), which is connected to the cold tank (7) below water level, natural convective mixing occurs between cold and hot waters. In addition, in these embodiments, an in-line heater (33) may be mounted onto line (25) for sanitizing water as it travels from the collection tank (3) to the cold tank (7), with the in-line heater (33) being positioned after the filter (6) (the positioning of the in-line heater (33) is the same in the embodiment shown in FIG. 8 as well). Still further, in the embodiment shown in FIG. 5, a pump (39) may be mounted onto the hot water line that delivers hot water through the external faucet and, similarly, another pump (40) may be mounted onto the cold water line that delivers cold water through the external faucet. The invention provides that pump (39) and pump (40) are capable of delivering water to the external faucets, even though such faucets are positioned higher than the water level within the cold tank (7) (and such pumps are configured to dispense specific volumes of water, based on pump operation times). Referring now to FIG. 6, according to certain related embodiments, the in-line heater (36) may also be mounted near the beginning of line (25), before or after pump (5) to heat and sanitize the water before it arrives to the filter (6).

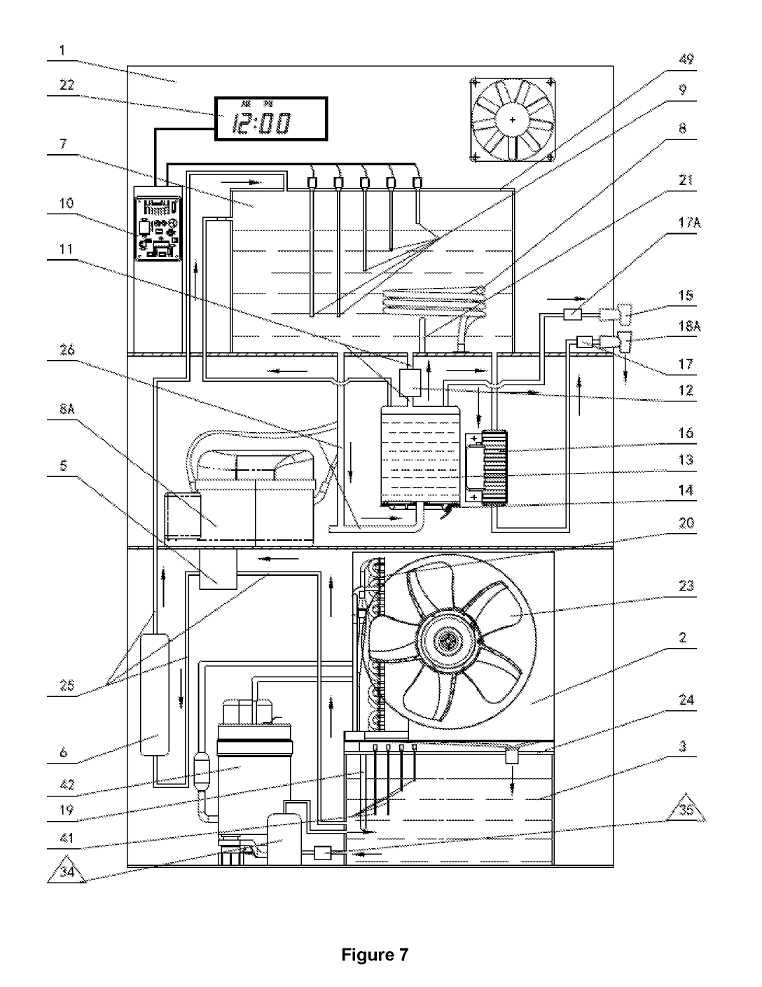

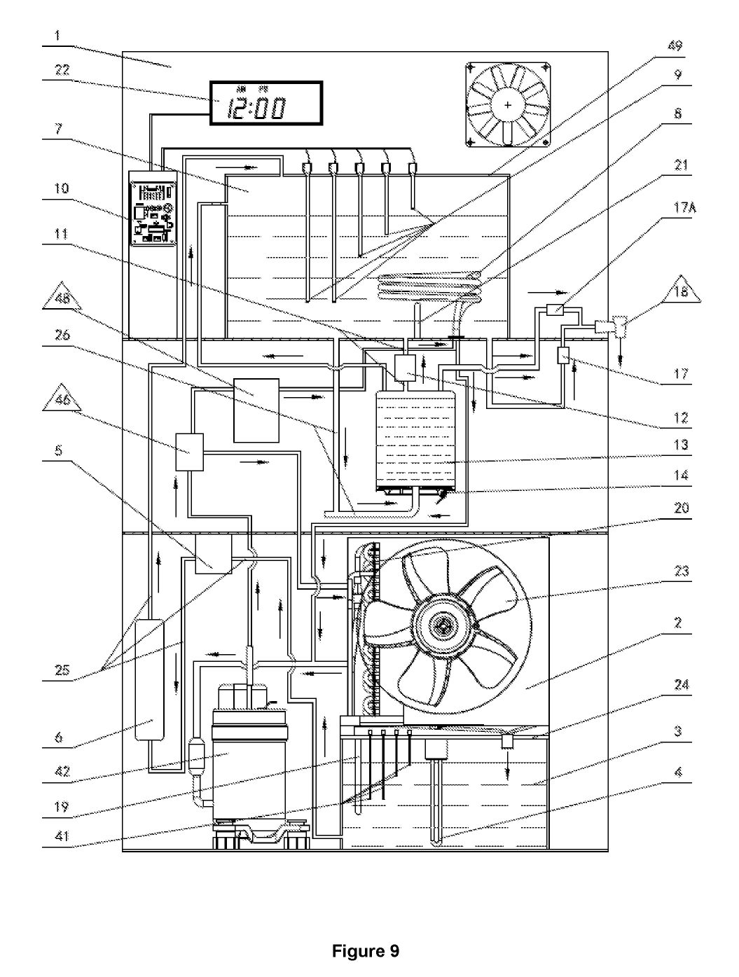

Referring now to FIG. 7, in yet further embodiments, the device may include a heater (34) that is operably coupled to the collection tank (3), with a solenoid valve (35) controlling recirculation of water inside of the collection tank (3) for sanitization purposes. Referring now to FIG. 9, another embodiment is shown that employs a single compressor (42) that is coupled to the evaporator (8) located in the cold water tank (7), and is also coupled to an evaporator (20) that is located within the dehumidifier component (2). According to such embodiments, the invention provides that refrigerant will flow through a three-way solenoid valve (46), to redirect flow of refrigerant—as needed—to execute water cooling procedures for the cold tank (7) and water condensation/harvesting procedures for the dehumidifier (2). The compressor (42) may be a variable frequency compressor, such that work cycles can be optimized and noise levels can be managed.

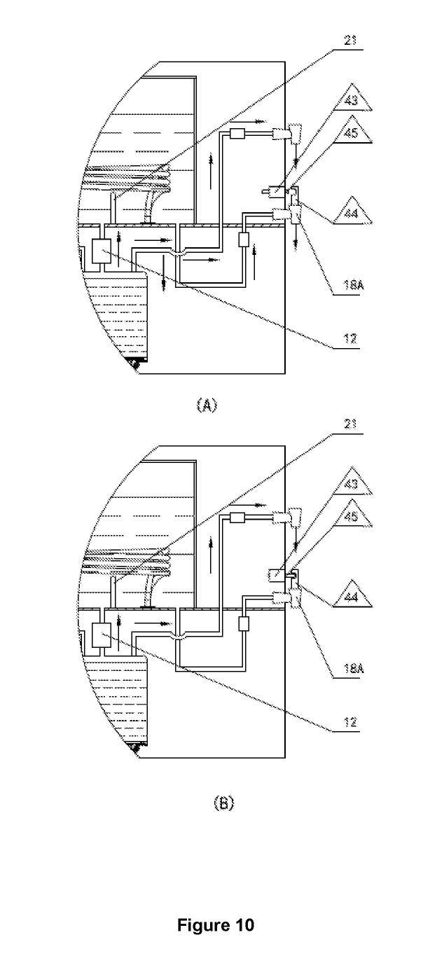

Referring now to FIG. 10, a diagram is provided that illustrates how the cold water mechanical faucet (18A) is restricted from dispensing hot water during a hot water sanitization procedure. More specifically, when the temperature sensor (21) detects a high water temperature (i.e., a temperature above a defined threshold), the temperature sensor (21) will activate, via the control board (10), an electromechanical solenoid (43), which causes a plunger (45) to move into a faucet actuator (44) to prevent the faucet actuator (44) from being pushed down, which would otherwise cause the cold water faucet (18A) to open. FIG. 10A shows the solenoid valve (43) in an inactivated position, while FIG. 10B shows the solenoid valve (43) in an activated position—with the locking plunger (45) of the solenoid (43) inserted into the faucet actuator rod (44) to immobilize the rod and to prevent the faucet actuator (44) from dispensing water (which serves to prevent scalding water from being dispensed from what is normally a cold water faucet). The invention provides that such features described above, and shown in FIG. 10, may be applied to both the cold water and hot water faucets of the device.

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A device for harvesting atmospheric water vapor, and condensing and sanitizing said water vapor, which comprises:
(a) a dehumidifier that is configured to harvest and condense atmospheric water vapor within the device;
(b) a collection tank that is configured to receive and collect condensed atmospheric water vapor within the dehumidifier;
(c) a first means for heating water within the collection tank to a temperature that is effective to kill bacteria contained therein;
(d) a first tube that fluidly connects the collection tank with a cold water tank, wherein the first tube comprises one or more in-line filters through which water must travel to reach the cold water tank;
(e) a second means for heating water within the cold water tank to a temperature that is effective to kill bacteria contained therein;
(f) a second tube that fluidly connects the cold water tank with a hot water tank, wherein the second tube is configured to enable convective mixing of hot and cold water in the hot tank; and
(g) one or more additional tubes for delivering cold water from the cold water tank and hot water from the hot water tank to one or more external faucets.

2. The device of claim 1, which further comprises a solenoid valve operably connected to a tube that fluidly connects the cold water tank to an external faucet, wherein the solenoid valve is configured to convert to a closed position when the device executes a high-temperature sanitization process within the cold water tank.

3. The device of claim 2, which further comprises a control board and temperature sensors that are operably connected to the control board, wherein the cold water tank, hot water tank, and collection tank each comprise at least one temperature sensor.

4. The device of claim 3, which further comprises a user interface display that may be operated to program the control board to execute sanitization procedures at defined points in time.

5. The device of claim 4, wherein the user interface display may further be programmed to cause the solenoid valve to convert to the closed position when the device executes the high-temperature sanitization process within the cold water tank.
